(19) United States
(12) Patent Application Publication
(10) Pub. No.: US 2016/0273560 A1
(43) Pub. Date: Sep. 22, 2016

(54) FLUID CYLINDER

(71) Applicant: Jungheinrich Aktiengesellschaft, Hamburg (DE)

(72) Inventors: Julia Leichnitz, Hamburg (DE); Frank Maenken, Henstedt-Ulzburg (DE)

(21) Appl. No.: 15/074,660

(22) Filed: Mar. 18, 2016

(30) Foreign Application Priority Data
Mar. 20, 2015 (DE) 10 2015 104 201.0

(51) Int. Cl. F15B 15/28; F15B 19/00

(52) U.S. Cl. CPC F15B 15/2846; F15B 19/005

(57) ABSTRACT

A fluid cylinder including a piston rod that is guided in a cylinder casing and on which a marking is provided with equidistantly arranged marks. An optical sensor unit is directed toward the marking. The optical sensor includes two or more equidistantly arranged optoelectronic sensor elements, which are configured to generate a binary output signal. The axial spacing between the optoelectronic sensor elements and the marks is such that each binary output signal includes a predetermined phase shift relative to the chronologically following output signal. The marking has at least one reference mark for which an output signal exists in all of the optoelectronic sensor elements. The optical sensor unit includes an error detection that converts the binary output signals from the optoelectronic sensor elements into a Gray code.

### CROSS REFERENCE TO RELATED APPLICATION

This application is based upon and claims priority under relevant sections of 35 USC §119 to German Patent Application No. 10 2015 104 201.0, filed Mar. 20, 2015, the entire contents of which are hereby incorporated by reference.

### BACKGROUND OF THE INVENTION

The present invention relates to a fluid cylinder having a piston rod guided in a cylinder casing on which a marking is provided with equidistantly arranged path marks. An optical sensor unit is directed toward the marking. With the assistance of the optical sensor unit, a stroke length and/or a stroke speed of the fluid cylinder can be detected.

An optical hybrid cylinder position sensor is known from DE 10 2005 059 251. The sensor serves as a position monitoring system, which detects the position of a movable element relative to a stationary sensor switch. The sensor switch detects the current position by means of an image evaluation in which the movement is determined by comparing two sequentially taken images.

A position measuring device for cylinder drives is known from WO 96/35098. With pneumatic or hydraulic cylinders, the moving piston rod is used as a path measuring system in which a pattern of dashes is generated on the piston rod only by the effect of a laser beam. A sensor based on optical reflection detects the dark dashes and the light gaps and can thereby identify the position of the piston rod.

A measuring and control device for a lifting platform is known from DE 102 42 630 A1, wherein a plurality of path marks are affixed on a movable body, a sensor directed toward the path marks detects the path marks, the number of path marks is totaled by an evaluation device, and a spacing is accordingly determined.

An industrial truck with a hydraulic cylinder is known from DE 10 2010 044 656 A1 and has a piston rod and cylinder casing in which the piston rod is guided. An optical sensor is provided in a head area, which has a light source directed toward the piston rod and a receiver for the reflected light. The optical sensor detects a movement of the piston rod relative to the sensor from the light reflected sequentially over time to the receiver.

A position measuring device in which the position of two objects relative to each other is measured is known from WO 84/01027. To accomplish this, a coded strip is affixed to one object, which has a pseudorandom binary sequence. A detection device is directed towards this sequence and detects it simultaneously at several locations in order to be able to determine a relative movement.

A position measuring device for a cylinder in which path marks are applied to a piston rod at different spacings is known from EP 1 426 737 B1. The position of the path marks is detected by an optical sensor.

A position scale with dashes is known from DE 693 07 135 T2, wherein the dashes have a first and second edge of which either the first or second edge is arranged in regular sections. The dashes possess two different widths, and a plurality of sequential dashes accordingly form an individual binary code for displaying the position of the dashes on the scale.

A position measuring device for fluid cylinders is known from AT 511 883, in which an image sensor detects a rectangular measuring section, and a detectable code pattern is applied to a piston rod.

A position measuring device is known from WO 2009/112895 A1, in which a change of the piston rod with different markings is detected by means of an optical photosensor.

A cylinder with an optical detection device is known from EP 1 461 585 B1. Fiber-optic sensor fields are arranged equidistantly with a quarter phase shift relative to an incremental marking so that changes do not occur simultaneously. The direction of movement and position of a piston rod relative to a starting point is determined from the sequence of arising changes.

A system for determining the position of a piston along its stroke path for a fluid dynamic actuator is known from EP 2 222 966 B1. Grooves are provided on the piston rod, which can be optically detected to determine position.

A system and a method for determining a relative position is known from U.S. 2013/0076346 A1. For this purpose, a field of code words is provided in which is encoded the position at which each is affixed.

### BRIEF SUMMARY OF THE INVENTION

The object of the invention is to provide a fluid cylinder that can detect the position of its piston rod in a simple and reliable manner. The fluid cylinder according to the invention has a piston rod guided in a cylinder casing on which a marking is provided with equidistantly arranged marks. Furthermore, the fluid cylinder possesses an optical sensor unit directed toward the marking. According to the invention, the sensor unit has two or more optoelectronic sensor elements arranged equidistantly relative to each other. The optoelectronic sensor elements each generate a binary output signal corresponding to the marking on the piston rod. According to the invention, the optoelectronic sensors are arranged relative to the marks in an axial direction such that each binary output signal possesses a predetermined phase shift relative to the chronologically following output signal. The phase shift of the output signals relative to each other permits a favorable spatial resolution of the sensor unit and allows the position, or respectively the change over time in the position, to be reliably detected. The detection of the position can be robust by using two or more than two optoelectronic sensor elements. Preferably, three optoelectronic sensor elements are used.

According to the invention, the marking also has at least one reference mark by means of which all the optoelectronic sensor elements respond simultaneously. The sensor unit possesses an error detection unit, which converts the incoming binary output signals of the optoelectronic sensor elements into a Gray code and checks whether more than one bit has changed in the event of a change in the output signals. The Gray code is a code known per se from information technology, which also comprises N-bits when N optoelectronic sensor elements are used. The Gray code is configured such that only one bit changes as time passes and the signals of the optoelectronic sensor elements change. The hamming distance of the Gray code is accordingly one (1). If the situation occurs in which more than one bit changes, a distinction can be drawn between two different cases. From this, the error detection unit can detect a measuring error in one of the optical sensor elements. In one preferred embodiment, a signal that is recognized as being faulty is recorded. If however all of the optical sensor elements respond, then the error detection unit assumes that a reference mark was detected as opposed to a faulty signal.

In one preferred embodiment of the invention, the marks each possess at least a length in an axial direction of the piston rod, which corresponds to the spacing of two neighboring marks. In an axial direction, the marking hence extends at least over the same length as the spacing between two neighboring marks.

In another preferred embodiment, the electronics of the sensor element always generate an output signal with a duty cycle of 0.5. The duty cycle of 0.5 means that, in the digital output signal, the state one (1) exists just as long as the state zero (0). The duty cycle of 0.5 can be achieved by adjusting the optoelectronic sensor element with its threshold value for light/dark recognition, together with the suitable extension of the marks in an axial direction.

In one preferred embodiment, the predetermined phase shift between two chronologically sequential output signals is an integral fraction of a full period. This means that the digital output signal itself occurs periodically with the output signals of the other optoelectronic sensor elements.

In one preferred embodiment, the integral fraction of the full period is equal to the number of optoelectronic sensor elements. This means that when three optoelectronic sensor elements are used, the signal sequence repeats after three complete periods of a signal.

In one preferred embodiment, the spacing (a) between the measuring axis of the sensor elements and the spacing (t) between the marks satisfies the following equation:

$$a = \frac{2 nt}{N} ,$$

where (N) is the number of sensor elements, and (n) is a natural number. The spacing (a) between the optoelectronic sensor elements is for example specified as the minimum spacing of the optoelectronic sensor elements without them influencing each other. The spacing (a) of the sensor elements arises from this spacing (t) between the marks given the number (n) and number (N) of sensor elements. The spacing (a) between the sensor elements is for example defined as the spacing between their measuring axes.

In one preferred development, the markings possess a predetermined extension in the peripheral direction, and the optoelectronic sensor elements are arranged offset from each other in the peripheral direction. In addition, the radial spacing of the optoelectronic sensor elements can vary relative to the marking and cylinder rod surface. In this context, the axial spacing between the optoelectronic sensor elements relevant for detecting position remains the same. The additional spacing in the peripheral direction, and/or in the radial direction, is not part of the coding, but rather increases the spacing between the measuring ranges of the contrast light sensors.

### BRIEF DESCRIPTION OF THE DRAWINGS

The invention will be further explained below using an exemplary embodiment. In the figures:

FIG. 1 shows a schematic view of the piston rod with its marking and the optical sensor unit directed toward it,

FIGS. 2a, b show the relative positioning between the marking and sensor unit in a view from the side and a view from above,

FIG. 3 shows a schematic view of the axial spacings between the marking and sensor unit,

FIG. 4 shows the chronological sequence of the sequence of signals,

FIG. 5 shows a depiction of the Gray code, and

FIG. 6 shows a section of the head section of the cylinder casing.

### DETAILED DESCRIPTION OF THE INVENTION

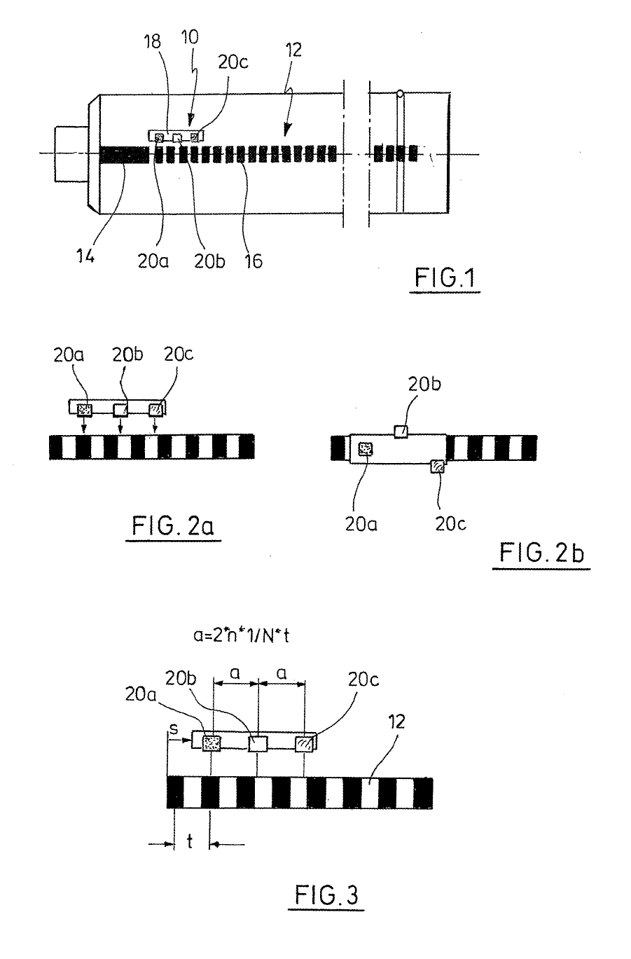

FIG. 1 shows a schematic view of a piston rod 10 with an applied marking 12, which is introduced into the chrome layer by tempering coloring with a laser. The marking 12 possesses at least one reference mark 14, which is distinguished by a long, continuous mark. The reference mark 14 possesses a length sufficient to be simultaneously detected by all the optoelectronic sensor elements. It is also alternatively possible for two sensor elements to respond in a first part of the reference mark 14, and for the third sensor element to respond in a second part separate from the first part. In order for a mark to qualify as a reference mark 14, all the sensor elements must respond independent of whether or not the mark is formed in one piece. Depending on the design, a plurality of marks 16 can also be applied to the piston rod. The marks 16 following the reference mark 14 in the axial direction consist of marks arranged equidistantly from each other, which are depicted in black.

A sensor unit 18 with three optoelectronic sensor elements 20a, 20b, 20c is schematically portrayed.

The optoelectronic sensor elements 20a, 20b, 20c are designed as light-emitting diodes with a corresponding receiver. A photodiode matched with the light emitting diode or a photo transistor can be used as the receiver. They receive a signal reflected from the piston rod, wherein the dark color of a mark correspondingly attenuates the signal proportionally. Through comparisons of the threshold value, the incoming signal is digitized such that a digitization of the signals has a duty cycle of 0.5. Preferably, a dark and/or black mark digitally represents a one (1).

As can be seen in FIG. 2a, the optoelectronic sensor elements 20a, 20b, 20c are sequential in an axial direction. The plan view in FIG. 2b shows that the contrast light sensors 20a, 20b, 20c can be distributed relative to each other in a peripheral direction. Due to the radial distribution, the geometric spacing of the contrast light sensors relative to each other is enlarged, and a mutual influencing of the contrast light sensors is avoided.

FIGS. 3 to 5 illustrate the signal processing and error recognition in the example of three optoelectronic sensor elements 20a, 20b, 20c. In the explanation, it is occasionally noted how the sensor unit and processing of the signals should be when (N) optoelectronic sensor elements are provided. In determining the ideal number of optoelectronic sensor elements, it should be considered that this poses certain demands on the extension of the sensor unit in an axial direction so that, as the number of optoelectronic sensor elements increases, the sensor element is built longer. The increase in axial length of the sensor unit depends on how the optoelectronic sensor elements are distributed in a peripheral direction around the piston rod, and how the sensor elements are constructed.

FIGS. 1 and 3 shows a sensor element 18 in which the three optoelectronic sensor elements 20a, 20b, 20c each possess the spacing (a) from measuring axis to measuring axis. Since the optoelectronic sensor elements are always arranged equidistant to each other, the quantity (a) can always designate the spacing between them.

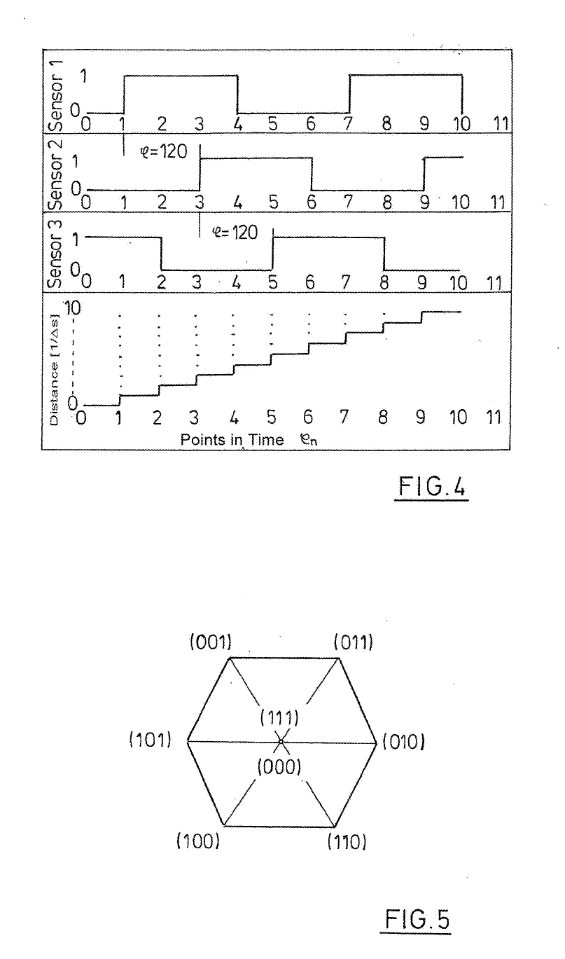

FIG. 4 shows the curve over time of the digital signals. In this context, the top row shows, for example, the digital signal of the optoelectronic sensor element 20a, the middle row shows the signal of the optoelectronic sensor element 20b, and the bottom row shows the signal of the optoelectronic sensor element 20c. It can be clearly seen that a phase angle of 120°=360°/3 predominates between the signals of the optoelectronic signal elements 20a and 20b.

The bottom diagram in FIG. 4 shows the detected path traveled by the marking relative to the sensor unit based on the signals of the optoelectronic sensor elements.

FIG. 5 shows a Gray code executed by the sensor unit 18. The signals of the optoelectronic sensor elements 20a, 20b, 20c are combined into a triple in each case. Since the marking is moved past the sensor unit during the measuring process and the output signals, which are generated possess a phase shift relative to each other, the situation naturally occurs that only one bit can change when the state changes. This means that the state change of the Gray code always occurs along the edges of the hexagon. If three sensor elements are located above a reference mark, i.e., above a single reference mark for three sensor elements or above a two-part reference mark, the triple [111] exists, and the mark is clearly recognized as the reference mark. The triple [000] cannot occur. If a change occurs by more than 1 bit, the signal is faulty. Faulty signals are recorded, and a corresponding status message is generated. Preferably an error is output, or the measurement is repeated.

It is important to understand that the reference mark can also be realized by changing just one bit, i.e., for example [011]->[111], [101]->[111] and [110]->[111]. Accordingly, the reference mark is not determined by the change of the bit, but is rather established by its value [111].

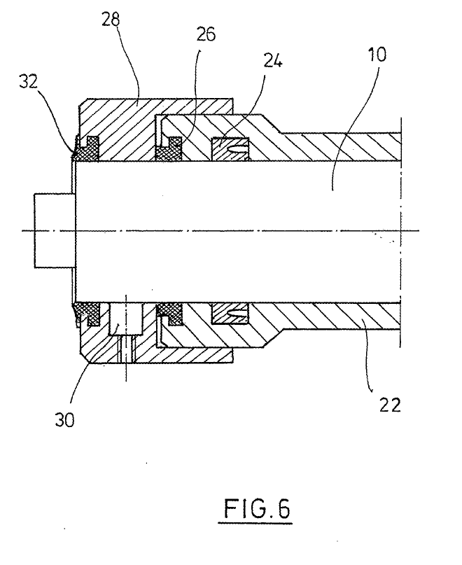

FIG. 6 shows a section of a cylinder head 22 in which a piston rod 10 is guided. The cylinder head 22 possesses a seal 24 in the form of a grooved ring and a wiper 26. A cap 28 is placed on the end of the cylinder head 22, and it possesses a cavity 30 for the sensor unit, which can be installed from the outside. On its end pointing away from the cylinder head, the cap 28 possesses an additional wiper 32. The cap is constructed so that a superimposed arrangement of the marking 12 (FIG. 1) and sensor unit 18 (FIG. 1) can be adjusted, and the cap can be subsequently fastened on the cylinder head secured against rotation.

1. A fluid cylinder comprising:
a piston rod that is guided in a cylinder casing and on which a marking is provided with equidistantly arranged marks; and
an optical sensor unit directed toward the marking, wherein the optical sensor comprises two or more equidistantly arranged optoelectronic sensor elements, each of which are configured to generate a binary output signal,
wherein the axial spacing between the optoelectronic sensor elements and the marks is dimensioned such that each binary output signal comprises a predetermined phase shift relative to the chronologically following output signal, and the marking has at least one reference mark for which an output signal exists in all of the optoelectronic sensor elements, and
wherein the optical sensor unit comprises an error detection which converts the incoming binary output signals from the optoelectronic sensor elements into a Gray code and, if there is a change in the output signals by more than one bit, recognizes a faulty signal, and if all the sensor elements respond, recognizes the at least one reference mark.

2. The fluid cylinder according to claim 1, wherein the equidistantly arranged marks comprise at least a length in an axial direction which corresponds to the spacing of two neighboring marks.

3. The fluid cylinder according to claim 1, wherein the optoelectronic sensor elements each generate an output signal with a duty cycle of 0.5.

4. The fluid cylinder according to claim 1, wherein the predetermined phase shift between two chronologically sequential output signals corresponds to an integral fraction of a full period.

5. The fluid cylinder according to claim 4, wherein the integral fraction of the full period corresponds to the number of optoelectronic sensor elements.

6. The fluid cylinder according claim 1, wherein the spacing between the optoelectronic sensor elements (a) and the spacing between the marks (t) satisfies the following equation:
$$a = \frac{2 n t}{N} ,$$
where (N) is the number of optoelectronic sensor elements, and (n) is a natural number.

7. The fluid cylinder according to claim 1, wherein the marks comprise a predetermined extension in the peripheral direction, and the optoelectronic sensor elements are arranged offset from each other in the peripheral direction.

8. The fluid cylinder according to claim 1, wherein a cap is provided for a cylinder head, wherein the piston rod is guided through the cylinder head and the cap, and a cavity is provided in the cap for the sensor unit.
